(19) United States
(12) Patent Application Publication
(10) Pub. No.: US 2023/0145142 A1
(43) Pub. Date: May 11, 2023

(54) MOTOR DRIVER AND HEAT PUMP

(71) Applicant: Mitsubishi Electric Corporation, Tokyo (JP)

(72) Inventors: Yuichi SHIMIZU, Tokyo (JP); Kazunori HATAKEYAMA, Tokyo (JP)

(21) Appl. No.: 17/917,986

(22) PCT Filed: Jun. 16, 2020
(86) PCT No.: PCT/JP2020/023633

§ 371 Date: Oct. 10, 2022

(51) Int. Cl. F25B 49/02; H02P 27/08

(52) U.S. Cl. CPC F25B 49/025; H02P 27/085; F25B 2600/021; F25B 2600/024

(57) ABSTRACT

A motor driver for driving a motor including three-phase windings includes: an inverter that applies a desired voltage to the motor; and an inverter controller that controls an operation of the inverter. The inverter includes: a current detector that detects a direct current in a first connecting line among three-phase connecting lines connecting the respective three-phase windings and the inverter; and a current detector that detects an alternating current in a second connecting line among the three-phase connecting lines, and a maximum direct current is caused to flow to the first connecting line in a first control mode for positioning a rotor of the motor.

### CROSS-REFERENCE TO RELATED APPLICATION

This application is a U.S. National Stage Application of International Application No. PCT/JP2020/023633 filed on Jun. 16, 2020, the contents of which are incorporated herein by reference.

### TECHNICAL FIELD

The present disclosure relates to a motor driver that drive a motor, and a heat pump.

### BACKGROUND

Conventionally, in a heat pump, a fan is used for the purpose of blowing air to a heat exchanger. Further, in the heat pump, a highly efficient permanent magnet synchronous motor is widely used to drive the fan. As a means for inexpensively driving a motor, position sensorless control technology for estimating a rotor position of the motor from a current of the motor without using a position sensor is widely known. For example, Patent Literature 1 discloses a technique of causing a direct current to flow through a motor at a start of the motor and drawing a rotor position of the motor to a desired position, in position sensorless control.

### PATENT LITERATURE

Patent Literature 1: Japanese Patent Application Laid-open No. 2017-221001

A method described in Patent Literature 1 is a method in which currents of two phases are detected by a current sensor, and a current of the remaining one phase is calculated using of a three-phase equilibrium condition. Patent Literature 1 does not clearly describe what kind of current sensor is used, but direct current transformer (DCCT) is used for two phases since alternating current current transformer (ACCT) cannot detect a DC amount. However, in general, there has been a problem that the DCCT is more expensive and costs more than the ACCT.

### SUMMARY

The present disclosure has been made in view of the above, and an object is to obtain a motor driver capable of performing overcurrent protection in control of causing a direct current to flow, with an inexpensive circuit configuration.

In order to solve the above-described problem and achieve the object, a motor driver according to the present disclosure drives a motor including three-phase windings. The motor driver includes an inverter that applies a desired voltage to the motor, and an inverter controller that controls an operation of the inverter. The inverter includes: a direct-current detector that detects a direct current in a first connecting line among three-phase connecting lines connecting the respective three-phase windings and the inverter; and an alternating-current detector that detects an alternating current in a second connecting line among the three-phase connecting lines. In a first control mode for positioning a rotor of the motor, the motor driver applies a maximum direct current to the first connecting line.

The motor driver according to the present disclosure has an effect of being able to perform overcurrent protection in control of causing a direct current to flow, with an inexpensive circuit configuration.

### BRIEF DESCRIPTION OF DRAWINGS

FIG. 1 is a diagram illustrating a configuration example of a heat pump according to a first embodiment.

FIG. 2 is a diagram illustrating a configuration example of an inverter according to the first embodiment.

FIG. 3 is a flowchart illustrating an operation of an inverter controller included in a motor driver according to the first embodiment.

FIG. 4 is a flowchart illustrating a detailed operation of a positioning control mode, in the inverter controller included in the motor driver according to the first embodiment.

FIG. 5 is a first diagram illustrating an example of an equivalent circuit indicating an energization state of the heat pump when the inverter controller according to the first embodiment is operating in the positioning control mode.

FIG. 6 is a first diagram illustrating an example of a magnetic flux vector generated by a motor of the heat pump according to the first embodiment.

FIG. 7 is a second diagram illustrating an example of a magnetic flux vector generated by the motor of the heat pump according to the first embodiment.

FIG. 8 is a second diagram illustrating an example of an equivalent circuit indicating an energization state of the heat pump when the inverter controller according to the first embodiment is operating in the positioning control mode.

FIG. 9 is a third diagram illustrating an example of a magnetic flux vector generated by the motor of the heat pump according to the first embodiment.

FIG. 10 is a diagram illustrating an example of a hardware configuration that implements the inverter controller included in the heat pump according to the first embodiment.

FIG. 11 is a first flowchart illustrating an operation of determining establishment of a transition condition from a voltage/frequency (V/F) control mode to a position sensorless control mode in an inverter controller included in a motor driver according to a second embodiment.

FIG. 12 is a first view illustrating an operation state of determining establishment of a transition condition from the V/F control mode to the position sensorless control mode, in the inverter controller included in the motor driver according to the second embodiment.

FIG. 13 is a second flowchart illustrating an operation of determining establishment of a transition condition from the V/F control mode to the position sensorless control mode, in the inverter controller included in the motor driver according to the second embodiment.

FIG. 14 is a second view illustrating an operation state of determining establishment of a transition condition from the V/F control mode to the position sensorless control mode, in the inverter controller included in the motor driver according to the second embodiment.

FIG. 15 is a flowchart illustrating an operation of the inverter controller included in the motor driver according to the second embodiment.

### DETAILED DESCRIPTION

Hereinafter, a motor driver and a heat pump according to an embodiment of the present disclosure will be described in detail with reference to the drawings.

### First Embodiment

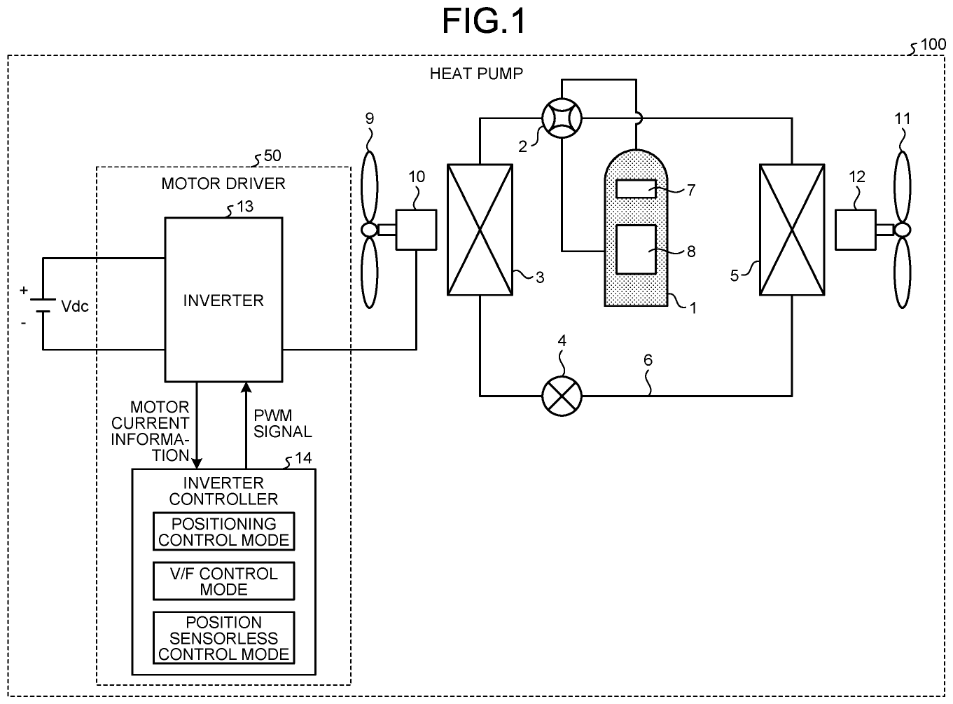

FIG. 1 is a diagram illustrating a configuration example of a heat pump 100 according to a first embodiment. The heat pump 100 is included in, for example, an air conditioner, a refrigerator, and the like. The heat pump 100 includes a refrigeration cycle in which a compressor 1, a four-way valve 2, a heat exchanger 3, an expansion mechanism 4, and a heat exchanger 5 are sequentially connected via a refrigerant pipe 6. The heat exchangers 3 and 5 perform heat exchange of a refrigerant. The compressor 1 includes a compression mechanism 7 that compresses a refrigerant, and a motor 8 that is for the compressor 1 and operates the compression mechanism 7. Further, the heat pump 100 includes a fan 9 that is for sending air to the heat exchanger 3, a motor 10 that is for driving the fan 9, a fan 11 that is for sending air to the heat exchanger 5, and a motor 12 that is for driving the fan 11. The motors 8, 10, and 12 are three-phase motors including three-phase windings of a U phase, a V phase, and a W phase (not illustrated). The motors 8, 10, and 12 are, for example, permanent magnet synchronous motors.

Further, the heat pump 100 includes an inverter 13 that applies a desired voltage to the motor 10 to drive, and an inverter controller 14 that controls an operation of the inverter 13. The inverter 13 is electrically connected to the motor 10. The inverter 13: uses, as an input power supply, a bus voltage Vdc which is a DC voltage; applies a voltage Vu to the U-phase winding of the motor 10; applies a voltage Vv to the V-phase winding of the motor 10; and applies a voltage Vw to the W-phase winding of the motor 10. The inverter controller 14 is electrically connected to the inverter 13. The inverter controller 14: generates a pulse width modulation (PWM) signal, which is a drive signal for driving the inverter 13, by using motor current information, which is information on a current flowing between the inverter 13 and the motor 10; and outputs the PWM signal to the inverter 13. As control modes for control of the operation of the inverter 13, the inverter controller 14 includes: a positioning control mode; a V/F control mode; and a position sensorless control mode.

In the heat pump 100, the inverter 13 and the inverter controller 14 constitute a motor driver 50. The motor driver 50 drives the motor 10. Note that, although not illustrated in FIG. 1, the heat pump 100 includes: an inverter that applies a voltage to the motor 8 to drive; and an inverter controller that controls an operation of the inverter that drives the motor 8. Similarly, the heat pump 100 includes: an inverter that applies a voltage to the motor 12 to drive; and an inverter controller that controls an operation of the inverter that drives the motor 12. The heat pump 100 individually drives the motors 8, 10, and 12 by including the inverter and the inverter controller, that is, a motor driver, for each of the motors 8, 10, and 12.

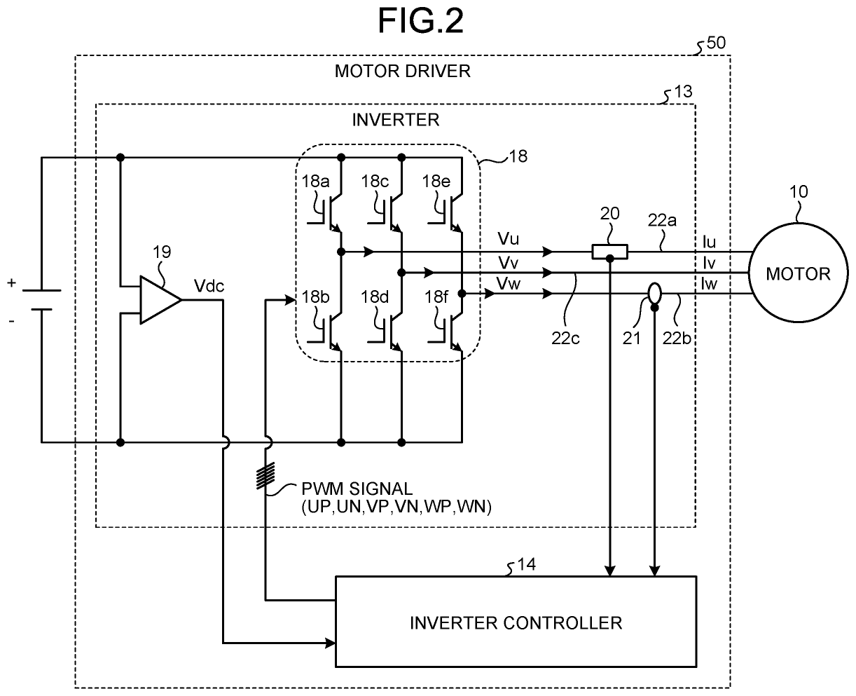

FIG. 2 is a diagram illustrating a configuration example of the inverter 13 according to the first embodiment. The inverter 13 includes a drive circuitry 18 that uses the bus voltage Vdc as an input power supply, and outputs voltages Vu, Vv, and Vw for three phases. The drive circuitry 18 includes six switching elements 18a to 18f, and has a configuration in which three series connection units are connected in parallel, which are: a series connection unit of the switching elements 18a and 18b; a series connection unit of the switching elements 18c and 18d; and a series connection unit of the switching elements 18e and 18f. The inverter 13 drives the switching elements 18a to 18f of the drive circuitry 18 corresponding to each PWM signal in accordance with PWM signals UP, UN, VP, VN, WP, and WN outputted from the inverter controller 14. In the example of FIG. 2: the switching element 18a is driven according to the PWM signal UP; the switching element 18b is driven according to the PWM signal UN; the switching element 18c is driven according to the PWM signal VP; the switching element 18d is driven according to the PWM signal VN; the switching element 18e is driven according to the PWM signal WP; and the switching element 18f is driven according to the PWM signal WN. The inverter 13: generate the voltages Vu, Vv, and Vw for three phases by driving the switching elements 18a to 18f of the drive circuitry 18; and applies voltages to individual windings of U phase, V phase, and W phase of the motor 10.

The inverter 13 includes a voltage detector 19 for detection of the bus voltage Vdc on an input side of the drive circuitry 18, that is, a side on which the bus voltage Vdc is supplied to the drive circuitry 18. The voltage detector 19 outputs a detected voltage value, that is, the bus voltage Vdc to the inverter controller 14. In order to detect a current flowing from the drive circuitry 18 to the motor 10, the inverter 13 includes a current detector 20 that detects a direct current flowing between the motor 10 and the inverter 13, in a first connecting line 22a among three-phase connecting lines connecting the respective three-phase windings of the motor 10 and the inverter 13. The current detector 20 outputs a detected current value, that is, a U-phase current Iu to the inverter controller 14. Further, in order to detect a current flowing from the drive circuitry 18 to the motor 10, the inverter 13 includes a current detector 21 that detects an alternating current flowing between the motor 10 and the inverter 13, in a second connecting line 22b among the three-phase connecting lines. The current detector 21 outputs a detected current value, that is, a W-phase current Iw to the inverter controller 14. Here, in the first embodiment, in the inverter 13, DCCT is used for the current detector 20 which is a direct-current detector, and ACCT is used for the current detector 21 which is an alternating-current detector. Note that, in FIG. 2, the DCCT is attached to the U-phase first connecting line 22a, and the ACCT is attached to the W-phase second connecting line 22b. However, this is an example, and a relationship between each current detector and a phase to be attached is not limited.

The switching elements 18a to 18f constituting the drive circuitry 18 of the inverter 13 are semiconductor switching elements. The semiconductor switching element is, for example, an insulated gate bipolar transistor (IGBT), a metal oxide semiconductor field effect transistor (MOSFET), or the like. The semiconductor switching element may have a configuration in which a reflux diode (not illustrated) is connected in parallel for the purpose of preventing a surge voltage due to switching. The reflux diode may be a parasitic diode of the semiconductor switching element. However, in a case of a MOSFET, it is also possible to realize a similar function by causing an ON state at a timing of reflux. In addition, a material included in the semiconductor switching element is not limited to silicon Si, and it is possible to realize low loss and high-speed switching by using silicon carbide SiC, gallium nitride GaN, gallium oxide Ga2O3, diamond, or the like, which is a wide bandgap semiconductor.

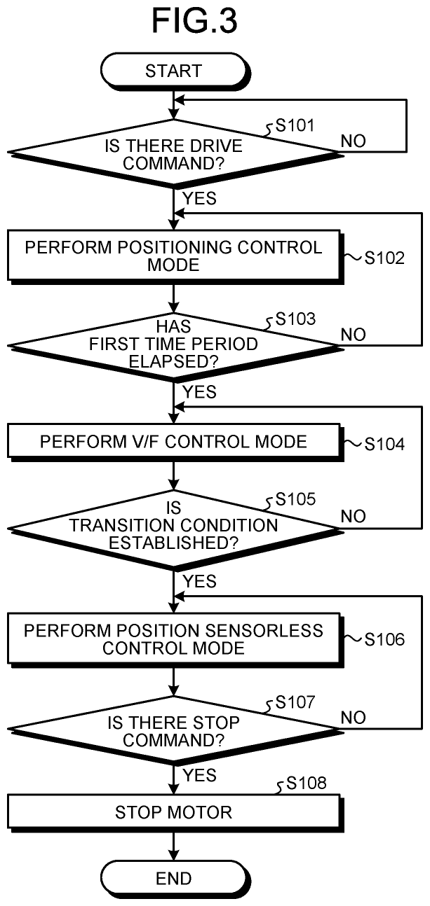

Next, an operation of the motor driver 50 will be described. FIG. 3 is a flowchart illustrating an operation of the inverter controller 14 included in the motor driver 50 according to the first embodiment. The inverter controller 14 determines whether or not there is a drive command to the motor 10 from a configuration in a preceding stage (not illustrated) (step S101). If there is no drive command (step S101: No), the inverter controller 14 waits until there is a drive command. If there is a drive command (step S101: Yes), the inverter controller 14 operates in the positioning control mode (step S102). The positioning control mode is a first control mode for controlling an operation of the inverter 13 to cause a direct current to flow from the inverter 13 to the motor 10, for the inverter controller 14 to draw a rotor position of the motor 10 to a desired position at a start of the motor 10. A detailed operation in the positioning control mode in the inverter controller 14 will be described later.

The inverter controller 14 determines whether or not a prescribed first time period has elapsed from a start of the operation in the positioning control mode (step S103). The first time period is a time period longer than a time period taken until the rotor position of the motor 10 is drawn to a desired position by causing a direct current to flow from the inverter 13 to the motor 10. The first time period may be changed by a current value of the direct current to flow to the motor 10. If the first time period has not elapsed (step S103: No), the inverter controller 14 continues the operation in the positioning control mode (step S102). If the first time period has elapsed (step S103: Yes), the inverter controller 14 transitions from the positioning control mode to the operation of the V/F control mode (step S104). The V/F control mode is generally known, and is a second control mode in which the inverter controller 14 drives the motor 10 by controlling the operation of the inverter 13 to increase an amplitude and a frequency of an output voltage from the inverter 13 in proportion to a speed command for the motor 10. The V/F control mode is a control mode in which the inverter controller 14 does not use current values acquired from the current detectors 20 and 21 as feedback.

The inverter controller 14 determines whether or not a prescribed transition condition is established during the operation in the V/F control mode (step S105). Details of the transition condition in the inverter controller 14 will be described in the second embodiment. If the transition condition is not established (step S105: No), the inverter controller 14 continues the operation in the V/F control mode (step S104). If the transition condition is established (step S105: Yes), the inverter controller 14 transitions from the V/F control mode to the operation of the position sensorless control mode (step S106). The position sensorless control mode is generally known, and is a third control mode by vector control capable of highly efficient driving in a case where the inverter controller 14 controls the operation of the inverter 13 to drive the motor 10. The position sensorless control mode is a control mode in which the inverter controller 14 performs estimation of a position of the rotor of the motor 10, current control, and the like by using the current values acquired from the current detectors 20 and 21 as feedback.

The inverter controller 14 determines whether or not there is a stop command to the motor 10 from a configuration in a preceding stage (not illustrated) (step S107). If there is no stop command (step S107: No), the inverter controller 14 continues the operation in the position sensorless control mode (step S106). If there is a stop command (step S107: Yes), the inverter controller 14 performs control to stop the motor 10 (step S108).

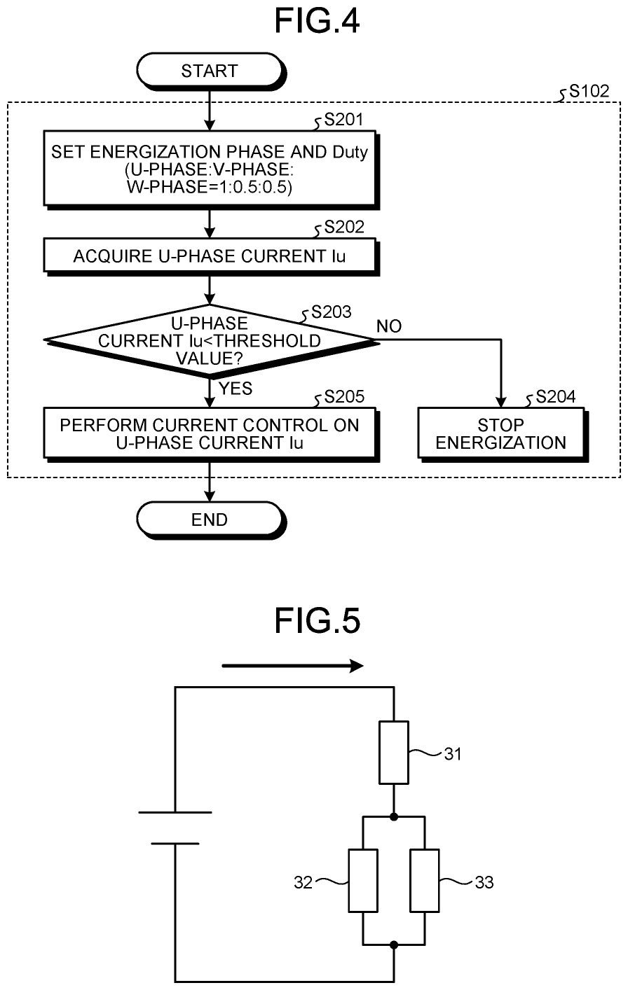

Here, a detailed operation of the positioning control mode in step S102 illustrated in the flowchart of FIG. 3 will be described. FIG. 4 is a flowchart illustrating a detailed operation in the positioning control mode, in the inverter controller 14 included in the motor driver 50 according to the first embodiment.

The inverter controller 14 sets an energization phase in which a direct current is caused to flow in the three-phase connecting lines, and sets Duty of a PWM signal for the switching elements 18a to 18f of the drive circuitry 18 corresponding to individual phases (step S201). In the first embodiment, in the positioning control mode, the inverter controller 14 sets, as a phase in which a maximum current flows, the U phase of the first connecting line 22a connected with the current detector 20 which is a DCCT. The maximum current is a current having a largest value among currents flowing through the three-phase connecting lines. That is, the inverter controller 14 applies a maximum direct current to the first connecting line 22a in the positioning control mode. The inverter controller 14 performs positioning control of the rotor of the motor 10 by causing a direct current to flow in accordance with the flowchart illustrated in FIG. 4. In order to control a current flowing through each of the U phase, the V phase, and the W phase, the inverter controller 14 performs PWM-control on the switching elements 18a to 18f of the drive circuitry 18 with a PWM signal, for example, and sets a ratio of the Duty of the switching elements 18a to 18f corresponding individually to the U phase, the V phase, and the W phase to U phase=1:V phase=0.5:W phase=0.5.

An energization state of the heat pump 100 at this time can be expressed by an equivalent circuit as illustrated in FIG. 5. FIG. 5 is a first diagram illustrating an example of an equivalent circuit indicating an energization state of the heat pump 100 when the inverter controller 14 according to the first embodiment is operating in the positioning control mode. Here, resistance values of: a U-phase resistance 31 indicating a resistance of the U-phase winding, wiring, and the like; a V-phase resistance 32 indicating a resistance of the V-phase winding, wiring, and the like; and a W-phase resistance 33 indicating a resistance of the W-phase winding, wiring, and the like, are assumed to be equal. In addition, in the equivalent circuit illustrated in FIG. 5, it is assumed that a direct current flows in a direction of an arrow. FIG. 5 illustrates that, in the heat pump 100, a maximum current flows in the U phase of the motor 10, and ½ of the maximum current of the U phase flows in the other V phase and W phase. In the inverter controller 14, a ratio of absolute values of a U-phase direct current flowing through the first connecting line 22a, a W-phase direct current flowing through the second connecting line 22b, and a V-phase direct current flowing through a third connecting line 22c among the three-phase connecting lines is assumed to be 1:0.5:0.5. That is, a current ratio of the U-phase current Iu flowing in the U phase:a V-phase current Iv flowing in the V phase:the W-phase current Iw flowing in the W phase=1:0.5:0.5.

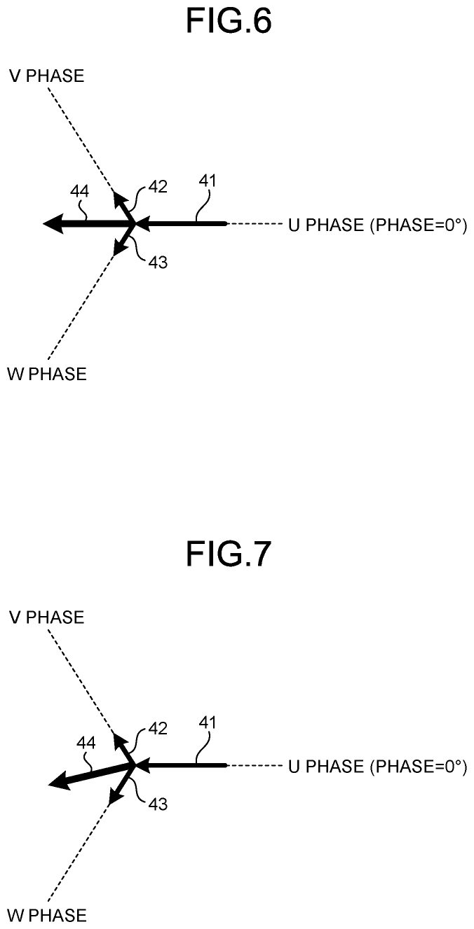

A magnetic flux vector generated in the motor 10 in such an energization state is as illustrated in FIG. 6. FIG. 6 is a first diagram illustrating an example of a magnetic flux vector generated by the motor 10 of the heat pump 100 according to the first embodiment. A resultant magnetic flux vector 44 of three-phase currents obtained by combining a magnetic flux vector 41 by the U-phase current Iu, a magnetic flux vector 42 by the V-phase current Iv, and a magnetic flux vector 43 by the W-phase current Iw has a direction on the U-phase axis, that is, a direction of the phase=0°, as illustrated in FIG. 6. Since the resultant magnetic flux vector 44 has a direction on the U-phase axis, the heat pump 100 can draw the rotor position of the motor 10 on the U-phase axis.

Further, in the heat pump 100, since the maximum current flows in the U phase even in a case where a winding resistance value of each phase varies, the rotor of the motor 10 can be positioned while overcurrent protection is appropriately performed, by monitoring the U-phase current Iu detected by the current detector 20. For example, in FIG. 5, a case is assumed in which there is no variation in the U-phase resistance 31, a variation in the V-phase resistance 32 is +5%, and a variation in the W-phase resistance 33 is −5%. Even in this case, the maximum current flows in the U phase of the motor 10, but the current ratio is to be the U-phase current Iu flowing in the U phase:the V-phase current Iv flowing in the V phase:the W-phase current Iw flowing in the W phase≈1:0.48:0.52.

FIG. 7 is a second diagram illustrating an example of a magnetic flux vector generated by the motor 10 of the heat pump 100 according to the first embodiment. In the resultant magnetic flux vector 44 of three-phase currents obtained by combining the magnetic flux vector 41 by the U-phase current Iu, the magnetic flux vector 42 by the V-phase current Iv, and the magnetic flux vector 43 by the W-phase current Iw, a direction is shifted from the U-phase axis, that is, shifted from the phase=0°, as illustrated in FIG. 7. Even in this case, the heat pump 100 can draw the rotor position of the motor 10 in the direction of the resultant magnetic flux vector 44 illustrated in FIG. 7.

The description returns to FIG. 4. The inverter controller 14 acquires the U-phase current Iu from the current detector 20 (step S202). The inverter controller 14 compares the U-phase current Iu with a threshold value defined for overcurrent protection (step S203). If the U-phase current Iu is equal to or larger than the threshold value (step S203: No), the inverter controller 14 stops energization from the inverter 13 to the motor 10, for overcurrent protection (step S204). That is, in the positioning control mode, the inverter controller 14 stops energization to the motor 10 when a current value of the current detector 20 becomes equal to or larger than a prescribed threshold value. In this case, the inverter controller 14 also ends the operation of the flowchart illustrated in FIG. 3. If the U-phase current Iu is less than the threshold value (step S203: Yes), the inverter controller 14 performs current control on the U-phase current Iu (step S205). The current control for the U-phase current Iu is, for example, control by proportional integral (PI) control. As described above, in a case where the first time period has not elapsed (step S103: No), the inverter controller 14 continues the operation in the positioning control mode in step S102, that is, steps S201 to S205.

Note that the inverter controller 14 only needs to cause the maximum current to flow through the first connecting line 22a connected with the current detector 20, that is, the U phase. Therefore, for example, the inverter controller 14 may control Duty of each phase such that a current does not flow in the third connecting line 22c, that is, the V phase, and currents of the U phase of the first connecting line 22a and the W phase of the second connecting line 22b have an equal value.

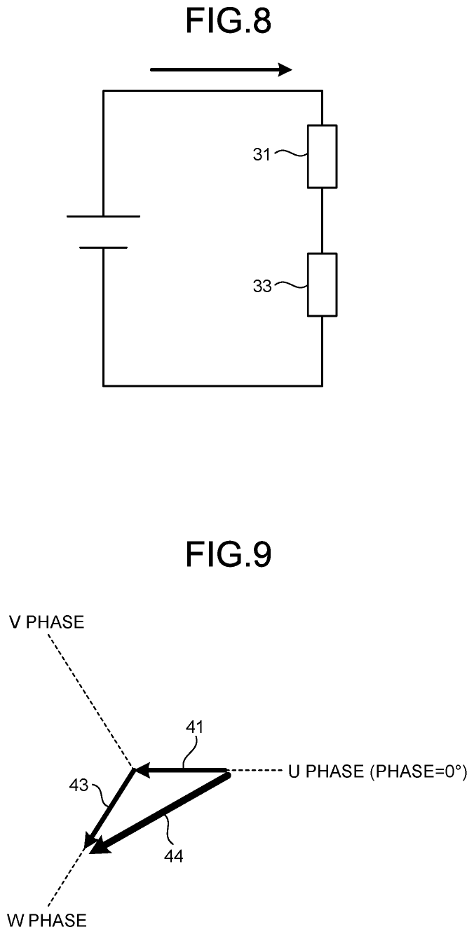

An energization state of the heat pump 100 at this time can be expressed by an equivalent circuit as illustrated in FIG. 8. FIG. 8 is a second diagram illustrating an example of an equivalent circuit indicating an energization state of the heat pump 100 when the inverter controller 14 according to the first embodiment is operating in the positioning control mode. Here, a resistance value of the U-phase resistance 31 indicating a resistance of the U phase and a resistance value of the W-phase resistance 33 indicating a resistance of the W phase are equal. In addition, in the equivalent circuit illustrated in FIG. 8, it is assumed that a direct current flows in a direction of an arrow. FIG. 8 indicates that, in the heat pump 100, since the U phase and the W phase constitute a series circuit, equal currents, that is, the maximum currents flow through the U phase and the W phase of the motor 10, and no current flows through the other V phase. In the inverter controller 14, a ratio of absolute values of the U-phase direct current flowing through the first connecting line 22a, and the direct current flowing through the second connecting line 22b or the third connecting line 22c is set to 1:1. That is, a current ratio is to be the U-phase current Iu flowing in the U phase:the V-phase current Iv flowing in the V phase:the W-phase current Iw flowing in the W phase=1:0:1.

A magnetic flux vector generated in the motor 10 in such an energization state is as illustrated in FIG. 9. FIG. 9 is a third diagram illustrating an example of a magnetic flux vector generated by the motor 10 of the heat pump 100 according to the first embodiment. The resultant magnetic flux vector 44 of two-phase currents obtained by combining the magnetic flux vector 41 by the U-phase current Iu and the magnetic flux vector 43 by the W-phase current Iw is, as illustrated in FIG. 9, a vector connecting a start point of the magnetic flux vector 41 by the U-phase current Iu and an end point of the magnetic flux vector 43 by the W-phase current Iw. Even in this case, the heat pump 100 can draw the rotor position of the motor 10 in the direction of the resultant magnetic flux vector 44 illustrated in FIG. 9 while performing overcurrent protection. Even when there is a variation in resistance of each phase in the equivalent circuit illustrated in FIG. 8, the heat pump 100 can control a current value of each phase to a desired value by adjusting Duty of a switching element corresponding to the U phase or the W phase.

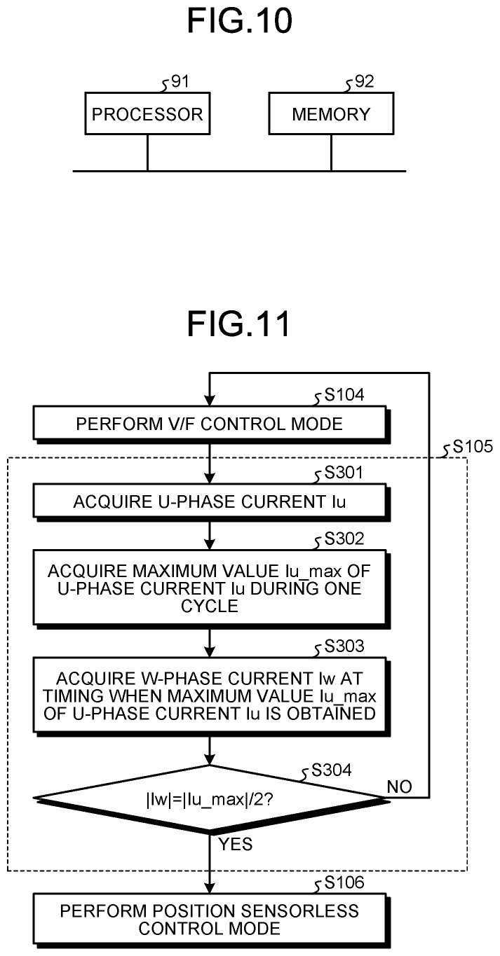

Next, a hardware configuration of the heat pump 100 will be described. FIG. 10 is a diagram illustrating an example of a hardware configuration that implements the inverter controller 14 included in the heat pump 100 according to the first embodiment. The inverter controller 14 is implemented by a processor 91 and a memory 92.

The processor 91 is a central processing unit (CPU) (may also be referred to as a central processing device, a processing unit, an arithmetic unit, a microprocessor, a microcomputer, a processor, or a digital signal processor (DSP)) or a system large scale integration (LSI). The memory 92 can be exemplified by a nonvolatile or volatile semiconductor memory such as a random access memory (RAM), a read only memory (ROM), a flash memory, an erasable programmable read only memory (EPROM), or an electrically erasable programmable read only memory (EEPROM) (registered trademark). In addition, the memory 92 is not limited thereto, and may be a magnetic disk, an optical disk, a compact disk, a mini disk, or a digital versatile disc (DVD). Note that the inverter controller 14 may include an electric circuit element such as an analog circuit or a digital circuit.

As described above, according to the first embodiment, in the heat pump 100, the motor driver 50 includes, between the inverter 13 and the motor 10, the current 20 which is DCCT and the current detector 21 which is ACCT. The inverter controller 14 uses a current value detected by the current detector 20 to perform an operation in the positioning control mode for causing a direct current to flow to draw the rotor of the motor 10 to a desired position. Thus, by adopting a circuit configuration in which two current detectors 20 and 21 are configured by combining the DCCT and the ACCT, the motor driver 50 can stably perform overcurrent protection in control of causing a direct current to flow, while realizing an inexpensive circuit configuration.

### Second Embodiment

In a second embodiment, a transition condition from the V/F control mode to the operation of the position sensorless control mode in step S105 of the flowchart illustrated in FIG. 3 of the first embodiment will be described.

A configuration of the heat pump 100 according to the second embodiment is similar to the configuration of the heat pump 100 according to the first embodiment illustrated in FIG. 1, and a configuration of the inverter 13 is similar to the configuration of the inverter 13 of the first embodiment illustrated in FIG. 2. In the inverter 13, since the current detector 21 is ACCT as described above, it is not possible to accurately detect a current in a low frequency region. In addition, the current detector 21 has individual differences, that is, variations in a frequency at which the current can be accurately detected. Therefore, when the inverter controller 14 transitions from the V/F control mode to the operation of the position sensorless control mode, it is necessary to increase a speed of the motor 10 to a frequency at which current detection by the current detector 21 which is ACCT can be accurately performed.

Therefore, in the second embodiment, during the operation in the V/F control mode, the inverter controller 14 compares a current value detected by the current detector 20, which is DCCT, with a current value detected by the current detector 21 which is ACCT, to monitor whether or not the current detector 21 which is ACCT is in a state of being able to accurately detect a current. The inverter controller 14 transitions from the V/F control mode to the operation of the position sensorless control mode when the current detector 21 which is an ACCT is brought into a state of being able to accurately detect the current.

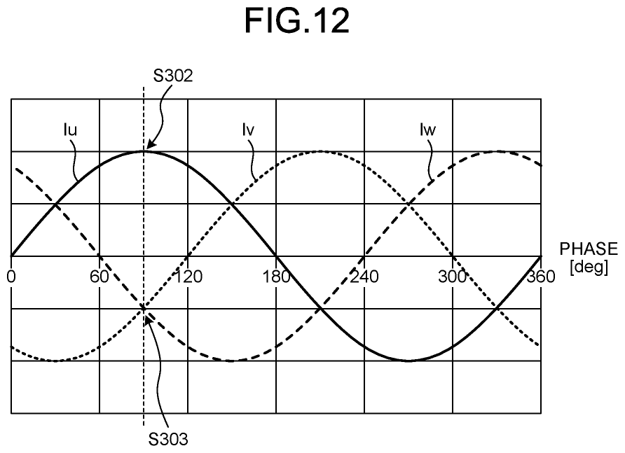

FIG. 11 is a first flowchart illustrating an operation of determining establishment of a transition condition from the V/F control mode to the position sensorless control mode, in the inverter controller 14 included in the motor driver 50 according to the second embodiment. The flowchart illustrated in FIG. 11 is an excerpt of a portion from step S104 to step S106 of the flowchart illustrated in FIG. 3. FIG. 12 is a first diagram illustrating an operation state of determining establishment of a transition condition from the V/F control mode to the position sensorless control mode, in the inverter controller 14 included in the motor driver 50 according to the second embodiment.

The inverter controller 14 acquires the U-phase current Iu from the current detector 20 (step S301). The inverter controller 14 compares the U-phase current Iu acquired from the current detector 20 for one cycle of a current, and acquires a maximum value Iu_max of the U-phase current Iu during one cycle of a current as illustrated in FIG. 12 (step S302). The inverter controller 14 acquires, from the current detector 21, the W-phase current Iw at a timing when the maximum value Iu_max of the U-phase current Iu is obtained (step S303). Here, if a driving frequency of the motor 10 is increased to a state in which the current detector 21 which is ACCT can accurately detect the current, a relationship between the maximum value Iu_max of the U-phase current Iu and the W-phase current Iw is expressed by Equation (1) as illustrated in FIG. 12, since the motor 10 has a three-phase equilibrium relationship.

|Iw|=|Iu_max|/2 (1)

Therefore, the inverter controller 14 can determine that the current detector 21, which is ACCT, can accurately detect the current when Equation (1) is established, and a transition can be made from the V/F control mode to the operation of the position sensorless control mode. In the flowchart illustrated in FIG. 11, the inverter controller 14 determines whether or not an absolute value of the W-phase current Iw is equal to ½ of an absolute value of the maximum value Iu_max of the U-phase current Iu (step S304). If the absolute value of the W-phase current Iw is not equal to ½ of the absolute value of the maximum value Iu_max of the U-phase current Iu (step S304: No), the inverter controller 14 determines that the transition condition is not established and continues the operation in the V/F control mode (step S104). If the absolute value of the W-phase current Iw is equal to ½ of the absolute value of the maximum value Iu_max of the U-phase current Iu (step S304: Yes), the inverter controller 14 determines that the transition condition is established, and transitions from the V/F control mode to the operation of the position sensorless control mode (step S106). That is, in a case where half of the absolute value of the maximum value Iu_max in one cycle of the U-phase current Iu detected by the current detector 20 is equal to the absolute value of the W-phase current Iw, which is the current value detected by the current detector 21 when the maximum value Iu_max is obtained by the current detector 20, the inverter controller 14 transitions from the V/F control mode to the operation of the position sensorless control mode.

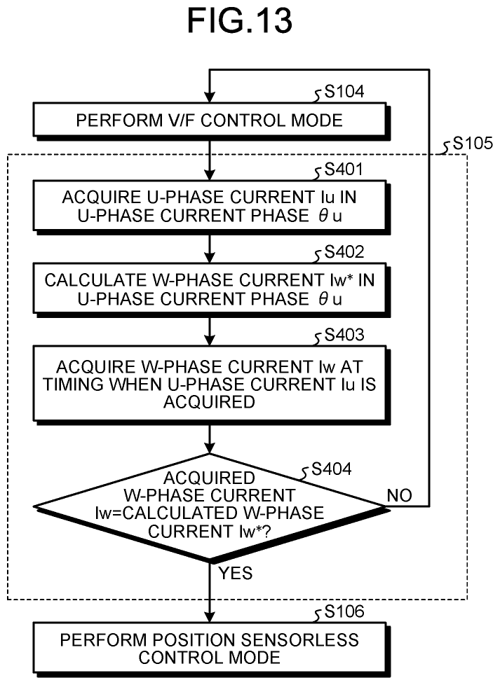

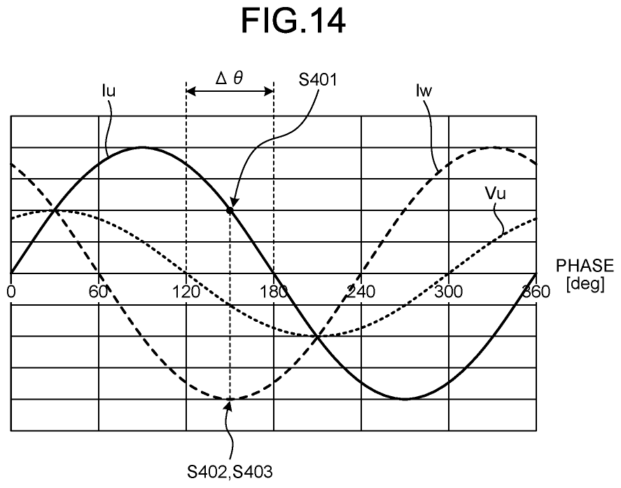

Note that a method for determining whether the transition condition from the V/F control mode to the position sensorless control mode is established in the inverter controller 14 is not limited to the method illustrated in FIGS. 11 and 12. FIG. 13 is a second flowchart illustrating an operation of determining establishment of a transition condition from the V/F control mode to the position sensorless control mode, in the inverter controller 14 included in the motor driver 50 according to the second embodiment. The flowchart illustrated in FIG. 13 is an excerpt of a portion from step S104 to step S106 of the flowchart illustrated in FIG. 3. FIG. 14 is a second diagram illustrating an operation state of determining establishment of a transition condition from the V/F control mode to the position sensorless control mode, in the inverter controller 14 included in the motor driver 50 according to the second embodiment.

The inverter controller 14 acquires the U-phase current Iu in a U-phase current phase θu from the current detector 20 (step S401). The inverter controller 14 estimates, that is, calculates a W-phase current Iw* in the U-phase current phase θu by using Equations (2) and (3) (step S402).

Iu_max=Iu/Sin(θu) (2)

Iw*=Iu_maxSin(θu+2π/3) (3)

Note that the inverter controller 14 may obtain the maximum value Iu_max of the U-phase current Iu obtained by Equation (2) by the method of step S302 of the flowchart illustrated in FIG. 11 described above. The inverter controller 14 acquires the W-phase current Iw at a timing when the U-phase current Iu in the U-phase current phase θu is acquired from the current detector 21 (step S403). The inverter controller 14 determines whether or not the W-phase current Iw acquired from the current detector 21 is equal to the calculated W-phase current Iw* (step S404). If the acquired W-phase current Iw is not equal to the calculated W-phase current Iw* (step S404: No), the inverter controller 14 determines that the transition condition is not established, and continues the operation in the V/F control mode (step S104). If the acquired W-phase current Iw is equal to the calculated W-phase current Iw* (step S404: Yes), the inverter controller 14 determines that the transition condition is established, and transitions from the V/F control mode to the operation of the position sensorless control mode (step S106). That is, the inverter controller 14: estimates a value of a current flowing through the second connecting line 22b when the U-phase current Iu, which is a first current value, is detected by the current detector 20; and transitions from the V/F control mode to the operation of the position sensorless control mode in a case where the estimated value of the current is equal to the W-phase current Iw, which is a second current value, detected by the current detector 21 when the first current value is detected by the current detector 20.

As described above, by comparing a U-phase voltage command, that is, phase information of the voltage Vu, a zero-cross point of the U-phase current Iu obtained from the current detector 20, and the like during the V/F control mode as illustrated in FIG. 14, the inverter controller 14 can obtain a phase difference A between the voltage Vu and the U-phase current Iu, and can estimate the U-phase current phase θu, which is a phase of the U-phase current Iu. If the U-phase current phase θu is known, since the remaining currents of the other phases have a phase difference of 120 degrees, the inverter controller 14 can calculate, from a trigonometric function, a V-phase current Iv* and the W-phase current Iw* that are ideal, that is, that are obtained in a case of being three-phase equilibrium with respect to the U-phase current Iu. Therefore, the inverter controller 14 can determine that the current detector 21 is in a state of being able to accurately detect the current, as long as the W-phase current Iw′, which is an estimated value of the W-phase current Iw in an identical phase obtained from an instantaneous value of the U-phase current Iu and the U-phase current phase θu, coincides with the W-phase current Iw obtained from the current detector 21.

Note that, when comparing the W-phase current Iw obtained from the current detector 21, which is ACCT, with the calculated W-phase current Iw′, the inverter controller 14 may provide a margin of about several percent to a dozen percent for the calculated W-phase current Iw′, in consideration of an influence of variation in accuracy of the current detector 21, noise, and the like. That is, the inverter controller 14 may determine that the W-phase current Iw coincides with the W-phase current Iw* in a case where the W-phase current Iw obtained from the current detector 21 is within a range of the margin set for the calculated W-phase current Iw*.

As described above, according to the second embodiment, in the heat pump 100, the inverter controller 14 of the motor driver 50: determines whether or not a relationship between a current value acquired from the current detector 20 which is DCCT and a current value acquired from the current detector 21 which is ACCT is three-phase equilibrium; and transitions to the operation of the current feedback control such as the position sensorless control mode from the non-current feedback control such as the V/F control mode, when individual current values become the three-phase equilibrium state. As described above, the motor driver 50 can stably transition from the V/F control mode to the position sensorless control mode even in a circuit configuration in which the two current detectors 20 and 21 are configured by combining DCCT and ACCT.

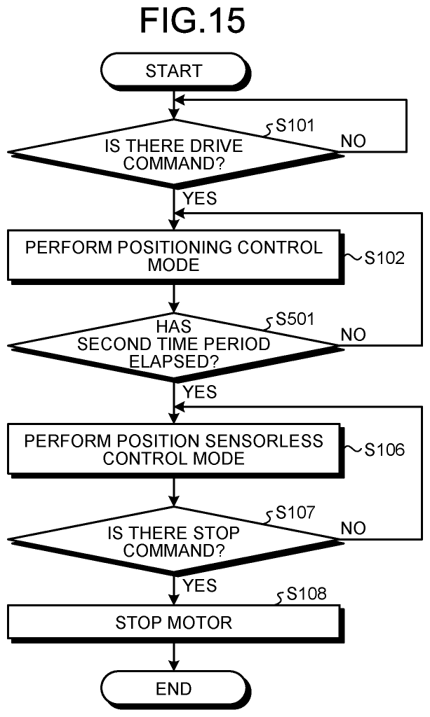

Note that, in a case of providing, as a driving frequency at a start of the motor 10, a frequency sufficient for ensuring current detection accuracy of the current detector 21 which is ACCT, the heat pump 100 may transition from the positioning control mode to the operation of the position sensorless control mode directly without executing the V/F control mode. FIG. 15 is a flowchart illustrating an operation of the inverter controller 14 included in the motor driver 50 according to the second embodiment. Instead of step S103 of the flowchart illustrated in FIG. 3 of the first embodiment, the inverter controller 14 determines whether or not a prescribed second time period has elapsed from a start of the operation in the positioning control mode (step S501). The second time period is assumed to be a time period longer than a time period taken to ensure the current detection accuracy of the current detector 21. The second time period may be changed by a current value of the direct current to flow to the motor 10. If the second time period has not elapsed (step S501: No), the inverter controller 14 continues the operation in the positioning control mode (step S102). If the second time period has elapsed (step S501: Yes), the inverter controller 14 transitions from the positioning control mode to the operation of the position sensorless control mode (step S106).

The configuration illustrated in the above embodiment illustrates one example and can be combined with another known technique, and it is also possible to combine embodiments with each other and omit and change a part of the configuration without departing from the subject matter of the present invention.

1. A motor driver adapted to drive a motor, the motor comprising three-phase windings, the motor driver comprising:
an inverter adapted to apply a desired voltage to the motor; and
an inverter controller adapted to control an operation of the inverter, wherein
the inverter comprises:
a direct-current detector adapted to detect a direct current in a first connecting line among three-phase connecting lines, the three-phase connecting lines connecting the respective three-phase windings and the inverter; and
an alternating-current detector adapted to detect an alternating current in a second connecting line among the three-phase connecting lines, wherein
the inverter controller uses a direct current detected by the direct-current detector and an alternating current detected by the alternating-current detector in controlling an operation of the inverter, and
in a first control mode of positioning a rotor of the motor, the inverter controller is adapted to apply a maximum direct current in the first connecting line.

2. The motor driver according to claim 1, wherein
a ratio of absolute values of a direct current flowing through the first connecting line, a direct current flowing through the second connecting line, and a direct current flowing through a third connecting line among the three-phase connecting lines is set to 1:0.5:0.5.

3. The motor driver according to claim 1, wherein
a ratio of absolute values of a direct current flowing through the first connecting line and a direct current flowing through the second connecting line or a third connecting line among the three-phase connecting lines is set to 1:1.

4. The motor driver according to claim 1, wherein
energization to the motor is stopped when a current value of the direct-current detector becomes equal to or larger than a threshold value in the first control mode.

5. The motor driver according to claim 1, wherein
after a first time period elapses from a start of the first control mode, a transition is made to an operation of a second control mode in which the motor is driven while an amplitude and a frequency of an output voltage from the inverter to the motor are increased in proportion to a speed command for the motor.

6. The motor driver according to claim 5, wherein
in a case where half of an absolute value of a maximum value in one cycle of a current detected by the direct-current detector is equal to an absolute value of a current value detected by the alternating-current detector when the maximum value is obtained by the direct-current detector,
a transition is made to an operation of a third control mode in which the motor is driven by current feedback control using current values of the direct-current detector and the alternating-current detector.

7. The motor driver according to claim 5, wherein
a value of a current flowing through the second connecting line is estimated when a first current value is detected by the direct-current detector, and in a case where the estimated value of the current is equal to a second current value detected by the alternating-current detector when the first current value is detected by the direct-current detector,
a transition is made to an operation of a third control mode in which the motor is driven by current feedback control using current values of the direct-current detector and the alternating-current detector.

8. The motor driver according to claim 1, wherein
after a second time period elapses from a start of the first control mode,
a transition is made to an operation of a third control mode in which the motor is driven by feedback control using current values of the direct-current detector and the alternating-current detector.

9. A heat pump comprising:
a compressor adapted to compress a refrigerant;
a heat exchanger adapted to perform heat exchange of the refrigerant;
a fan adapted to send air to the heat exchanger;
a motor adapted to drive the fan; and
the motor driver, adapted to drive the motor, according to claim 1.
